(19) United States
(12) Patent Application Publication
(10) Pub. No.: US 2008/0036762 A1
(43) Pub. Date: Feb. 14, 2008

(54) System and Method for Generating Three-Dimensional Figures

(75) Inventors: Cheol-Yun Lee, Yongin-Si (KR); Ju-Ho Lee, Seoul (KR); Ju-Hyung Lee, Seoul (KR); Ju-Mi Lee, Yongin-Si (KR)

Correspondence Address: IPLA P.A., 3580 WILSHIRE BLVD., 17TH FLOOR, LOS ANGELES, CA, 90010, US

(73) Assignees: Cheol-Yun Lee, Yongin-Si, Gyeonggi-Do (KR); Ju-Ho Lee, Seoul (KR); Ju-Hyung Lee, Seoul (KR); Ju-Mi Lee, Yongin-Si, Gyeonggi-Do (KR); Modenbox Co., Ltd., Yongin-Si, Gyeonggi-Do (KR)

(21) Appl. No.: 11/571,988

(22) PCT Filed: Apr. 19, 2006
(86) PCT No.: PCT/KR06/01459

§ 371 Date: Jan. 11, 2007

(30) Foreign Application Priority Data
May 4, 2005 (KR) 10-2005-0037378

(51) Int. Cl. G06T 17/00

(52) U.S. Cl. 345/420

(57) ABSTRACT

The present invention relates to a system and method, which establish a plug-in relationship with a graphic program, such as Adobe Illustrator, and are adapted to reconstruct each face in three dimensions to include content designed in a two-dimensional development figure, thus converting a two-dimensional object into a three-dimensional object. In the three-dimensional design method, shapes of basic boxes are presented to a user. Dimensions corresponding to a box shape selected by the user are received. Coordinate values of a development figure are changed depending on the dimensions received from the user. A development figure suitable for the changed coordinate values is presented to the user. The design made by the user is partitioned to correspond to faces of the development figure. Three-dimensional coordinate values are set based on input coordinate values. The partitioned design is arranged on the three-dimensional coordinate values, thus generating three-dimensional data.

### TECHNICAL FIELD

The present invention relates, in general, to a system and method for converting a development figure drawn in a two-dimensional plane into a three-dimensional figure and, more particularly, to a system and method, which establish a plug-in relationship with a graphic program, such as Adobe Illustrator, and are adapted to reconstruct each face in three dimensions to include content designed in the form of a two-dimensional development figure, thus converting a two-dimensional object into a three-dimensional object.

### BACKGROUND ART

Generally, products, manufactured by folding sheets of paper or synthetic resin material, such as boxes or packing containers, are produced in such a way that a development figure is drawn, and paper or synthetic resin material is cut based on the development figure and is then folded. In this way, the development figure denotes a planar figure in which the faces of a three-dimensional figure are transferred onto a plane (cooperative conversion) without varying the lengths and angles of the faces, and are developed and drawn. The development figure is an essential element in the production of a packing box, etc.

In particular, such a development figure is essential to a design used for a packing box. Most computer programs used for design are constructed to perform a task in a two-dimensional plane, so that persons, desiring to produce a packing box, use a method of primarily drawing the development figure of a desired box and secondarily making a design on the drawn development figure.

However, such a method is problematic in that, in the case of a simple box, it is possible for a designing person to personally draw a development figure, but, when the shape of a box is complicated, an operation itself of drawing a development figure requires professional knowledge, and furthermore, design must be conducted again from the beginning in a subsequent box manufacturing stage if the design was made for the wrong development figure.

Further, there may frequently occur the case where, even if a design is made in a two-dimensional plane, a three-dimensional effect is not sufficiently shown, and an unsatisfactory design is obtained when an actual box is manufactured after the design has been completed. Accordingly, a method of allowing a design made in a two-dimensional plane to be viewed as a three-dimensional screen is required.

### DISCLOSURE OF INVENTION

### Technical Problem

Accordingly, the present invention has been made keeping in mind the above problems occurring in the prior art, and an object of the present invention is to provide a system and method, which allow a development figure for the shape of each packing box to be easily seen even without professional knowledge about a packing box, and which allow a design to be directly made on such a development figure.

Another object of the present invention is to provide a system and method, which fundamentally eliminate errors in generating a three-dimensional effect, etc. that may occur during a procedure of manufacturing an actual box after completing a design.

A further object of the present invention is to provide a system and method, which, in advance, show color to be printed on a box, thus allowing a user to precisely select desired colors.

### Technical Solution

In order to accomplish the above objects, the present invention provides a three-dimensional design system, comprising a box database for storing classified box shapes, a development figure database for storing development figures of respective boxes, a coordinate setting unit for storing registration information about length, width and height of each development figure stored in the development figure database, and information about three-dimensional locations of respective faces, constituting the development figure, and for setting an axis of coordinates, a coordinate change unit for changing an axis of coordinates depending on the registration information input by a user, such as length, width and height, a three-dimensional figure generation unit for generating a three-dimensional figure based on information about coordinates changed through the coordinate change unit, a design unit including a design storage unit for storing designs corresponding to respective faces of the development figure, and a design application unit for applying the designs stored in the design storage unit to the three-dimensional figure generation unit.

Further, the present invention provides a three-dimensional design method using the three-dimensional design system, comprising the steps of presenting shapes of basic boxes to a user, receiving dimensions corresponding to a box shape selected by the user, changing coordinate values of a development figure depending on the dimensions received from the user, presenting a development figure suitable for the changed coordinate values to the user, partitioning a design made by the user to correspond to faces of the development figure, setting three-dimensional coordinate values based on input coordinate values, and arranging the partitioned design on the set three-dimensional coordinate values, thus generating three-dimensional data.

### Advantageous Effects

According to the present invention, there are advantages in that, even if there is no professional knowledge about a packing box, not only can a development figure for each packing box shape be easily viewed, but also a design can be directly made on the development figure, and a shape, apparent when the design personally made by a user is implemented in a three-dimensional structure having a box shape, can be visually seen.

### BRIEF DESCRIPTION OF THE DRAWINGS

FIG. 1 is a screen allowing a user to select a box shape according to an embodiment of the present invention;

FIG. 2 is a screen for inputting dimensions according to an embodiment of the present invention;

FIG. 3 is a development figure according to an embodiment of the present invention; and

FIG. 4 is a diagram showing a design made on the development figure according to an embodiment of the present invention.

### BEST MODE FOR CARRYING OUT THE INVENTION

Hereinafter, embodiments of the present invention will be described in detail with reference to the attached drawings.

A three-dimensional design system of the present invention includes a box database for storing classified box shapes, a development figure database for storing development figures of respective boxes, a coordinate setting unit for storing registration information about length, width and height of each development figure stored in the development figure database, and information about three-dimensional locations of respective faces, constituting the development figure, and for setting an axis of coordinates, a coordinate change unit for changing an axis of coordinates depending on the registration information input by a user, such as length, width and height, a three-dimensional figure generation unit for generating a three-dimensional figure based on information about coordinates changed through the coordinate change unit, a design unit including a design storage unit for storing designs corresponding to respective faces of the development figure, and a design application unit for applying the designs stored in the design storage unit to the three-dimensional figure generation unit.

Further, a three-dimensional design method of the present invention includes the steps of presenting shapes of basic boxes to a user, receiving dimensions corresponding to a box shape selected by the user, changing coordinate values of a development figure depending on the dimensions received from the user, presenting a development figure suitable for the changed coordinate values to the user, partitioning a design made by the user to correspond to faces of the development figure, setting three-dimensional coordinate values based on input coordinate values, and arranging the partitioned design on the set three-dimensional coordinate values, thus generating three-dimensional data.

The box database stores information about basic layout required to classify all boxes, the development figures of which are stored, and to display the classified boxes according to category. The box database can be constructed using various categories, for example, a basic type, a modified type and other types, can be constructed based on polygons, such as a triangle, a square or a pentagon, or can be constructed depending on whether a handle exists, etc.

The development figure database stores the development figures of respective boxes to be shown to a user in the box database, and displays each development figure on a user screen to allow the user to personally make a design on the development figure.

The coordinate setting unit has registration information about each development figure, that is, numerical information, such as length, width and height, and information about three-dimensional locations of respective faces of each individual development figure in the three-dimensional figure. For example, in the case of a square pillar-shaped box having a width of 50 mm, a length of 70 mm and a height of 30 mm, if the development figure of the square pillar-shaped box is considered, the coordinate setting unit has numerical information about the box composed of two faces each having a size of 50 mm×70 mm, two faces each having a size of 70 mm×30 mm, and two faces each having a size of 50 mm×30 mm, and information about three-dimensional locations of respective faces thereof.

The coordinate change unit changes the stored axis of coordinates depending on variation in the size of a box input by the user. For example, if the size of a box is increased by a width of 10 mm, a length of 20 mm, and a height of 10 mm, coordinate values are changed in proportion to the increased size.

The three-dimensional figure generation unit applies the numerical values, changed through the coordinate change unit, to each face of the development figure, based on the registration information about each face that has been set by the coordinate setting unit, and generates the face of the development figure in three dimensions. Further, the design application unit applies a design stored for each face to the three-dimensional figure generation unit, thus allowing the design made by the user to be displayed in three-dimensional space.

The design unit may further include a color correction unit. The color correction unit sets a background color corresponding to the material of a portion of a box, on which a corresponding design is located, corrects variation in color produced when a color designated by the user is printed on the set background color, and notifies the user of the correction of color variation, thereby allowing the user to make a design using suitable color.

That is, if the user selects the material of a box, the development figure, design, color, etc. of the box drawn in a background color, that is, white color, are adjusted to show how colors will appear when they are printed on the basic color of the material of the box selected by the user.

Further, the design unit may further include an ink consumption measurement unit. That is, each design color is calculated in pixels, preset ink consumption per pixel is multiplied by the calculated color, and the multiplication result value is multiplied again by the price of ink, thus precisely calculating ink consumption and detailed costs incurred by the ink consumption.

### Mode for the Invention

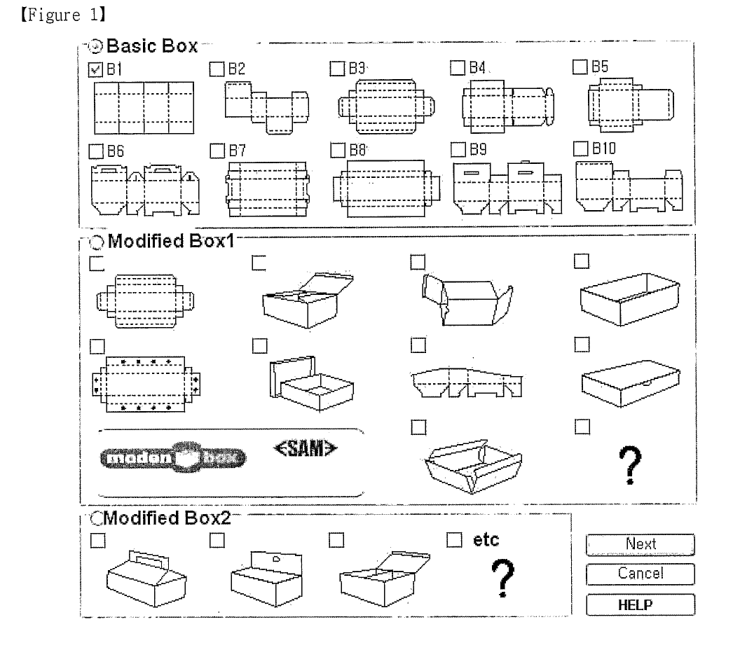

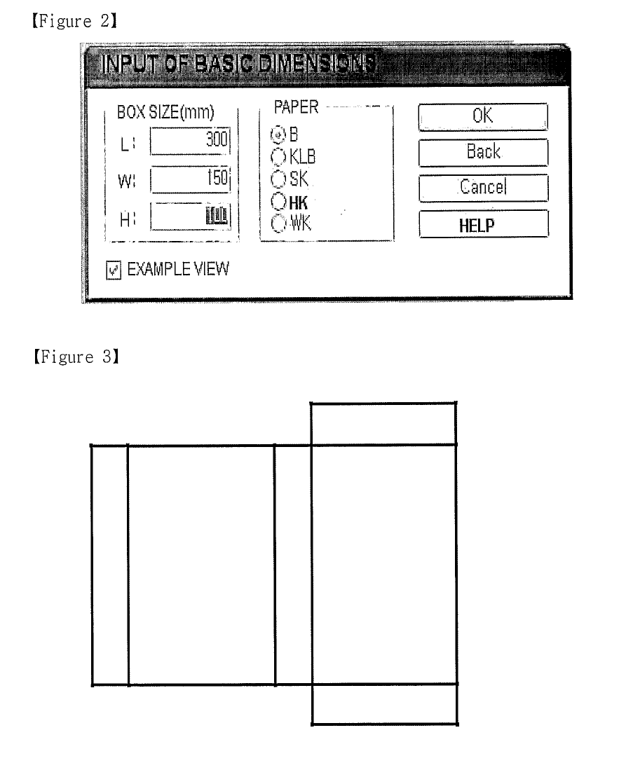

FIG. 1 is a screen allowing a user to select a box shape according to an embodiment of the present invention. From the diagram of FIG. 1, the user can select a specific box shape. FIG. 1 illustrates respective figures stored in a box database, and shows the layout of the boxes. In FIG. 1, development figures stored in a development figure database can be displayed as they are. If the user selects any one from among the boxes shown in FIG. 1 in this way, a screen for inputting dimensions is displayed, as shown in FIG. 2. If the user inputs box registration information, such as width, length and height, the development figure of FIG. 3 is displayed on the user screen. As the development figure of FIG. 3, a development figure stored in the development figure database is used.

The development figure stored in the development figure database has a shape in which six respective faces, including a top face, a bottom face, side faces, a rear face, and a front face, are developed. The location of each face on the three-dimensional figure and the shape of the three-dimensional figure based on basic dimensions are recorded in the coordinate setting unit. The coordinate setting unit presets coordinate values depending on information about each face size in the case of a box having, for example, a square pillar shape. If the user changes coordinate values by inputting size, the coordinate setting unit reflects the size changed using the coordinate change unit.

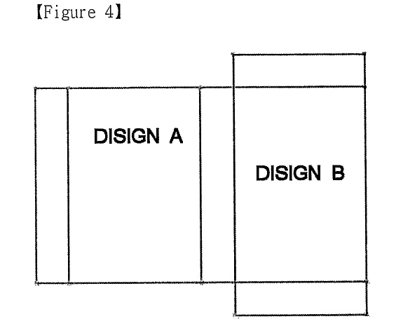

If the user makes a desired design on the development figure shown in FIG. 3, or loads a previously stored design and places the design on the development figure, the location of each face, in which the placed design exists, on the development figure, is recorded. That is, as shown in FIG. 4, if a design including, for example, the text “Design A”, is placed on the development figure, the placed design is partitioned to correspond to faces.

If the user desires to view a three-dimensional figure after completing the design, the three-dimensional figure generation unit generates a corresponding three-dimensional figure, based on information about the coordinates changed through the coordinate change unit, and the design application unit places the partitioned design on each face of the generated three-dimensional figure.

The design placed in this way is shown to the user as a three-dimensional screen. The user rotates each face on the three-dimensional screen by dragging a mouse, etc., and is then capable of reevaluating the overall design.

Further, each design has corresponding color information, so that respective color values are calculated in pixels, and are converted into Cyan (C), Magenta (M), Yellow (Y), and Black (K). Thereafter, preset ink consumption per pixel is calculated, so that ink consumption for each of C, M, Y and K can be calculated, and costs required for the ink consumption can also be calculated if the ink consumption is multiplied by the price of each ink.

### INDUSTRIAL APPLICABILITY

According to the present invention, there are advantages in that, even if there is no professional knowledge about a packing box, not only can a development figure for each packing box shape be easily viewed, but also a design can be directly made on the development figure, and a shape, apparent when the design personally made by a user is implemented in a three-dimensional structure having a box shape, can be visually seen.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A three-dimensional design system, comprising:
a box database for storing classified box shapes;
a development figure database for storing development figures of respective boxes;
a coordinate setting unit for storing registration information about length, width and height of each development figure stored in the development figure database, and information about three-dimensional locations of respective faces, constituting the development figure, and for setting an axis of coordinates;
a coordinate change unit for changing an axis of coordinates depending on the registration information input by a user, such as length, width and height;
a three-dimensional figure generation unit for generating a three-dimensional figure based on information about coordinates changed through the coordinate change unit;
a design unit including a design storage unit for storing designs corresponding to respective faces of the development figure; and
a design application unit for applying the designs stored in the design storage unit to the three-dimensional figure generation unit.

2. The three-dimensional design system according to claim 1, further comprising a color correction unit for setting a background color corresponding to material of a portion of a box, on which a corresponding design is located, correcting variation in color produced when a color designated by the user is printed on the set background color, and notifying the user of the correction of color variation.

3. The three-dimensional design system according to claim 1, wherein the design system establishes a plug-in relationship with an Adobe Illustrator.

4. The three-dimensional design system according to claim 1, wherein the design system is implemented in a server-client environment.

5. A three-dimensional design method, comprising the steps of:
presenting shapes of basic boxes to a user;
receiving dimensions corresponding to a box shape selected by the user;
changing coordinate values of a development figure depending on the dimensions received from the user;
presenting a development figure suitable for the changed coordinate values to the user;
partitioning a design made by the user to correspond to faces of the development figure;
setting three-dimensional coordinate values based on input coordinate values; and
arranging the partitioned design on the set three-dimensional coordinate values, thus generating three-dimensional data.
